(19) United States
(12) Patent Application Publication
(10) Pub. No.: US 2007/0061268 A1
(43) Pub. Date: Mar. 15, 2007

(54) Prepaid or pay-as-you-go software, content and services delivered in a secure manner

(75) Inventors: Jeffrey Alan Herold, Bellevue, WA (US); Munisamy Prabu, Issaquah, WA (US); Thomas G. Phillips, Bellevue, WA (US); James S. Duffus, Seattle, WA (US); Curt A. Steeb, Redmond, WA (US); Paul C. Sutton, Seattle, WA (US); Zeyong Xu, Redmond, WA (US); Zhangwei Xu, Redmond, WA (US); Alexander Frank, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/224,651

(22) Filed: Sep. 12, 2005

(51) Int. Cl. G06Q 99/00

(52) U.S. Cl. 705/59

(57) ABSTRACT

A computer participates in a system for licensing use in a metered fashion using individual licenses cryptographically linked to the computer and a particular service provider or underwriter. The computer may have a cryptographic unit, secure memory, sanction and metering functions as part of a secure execution environment for enabling metered operation and conformance to a security policy. Payment for licenses may be made through a payment system with licenses generated at a server with access to cryptographic functions for verification of requests, certificate/key pair generation, and signing licenses.

### BACKGROUND

For some time, goods and services have been sold on a pay-per-use or subscription basis. Decades ago newspapers were sold on a subscription basis either prepaid or postpaid, that is payment was received before the delivery of the newspapers, or afterwards. Postpaid subscriptions assumed a certain amount of credit worthiness on the part of the subscriber. More recently, cellular telephones have been made available on a prepaid or a postpaid basis. The latter generally require subscription agreement where the consumer is legally bound to pay for the services used prior to payment.

To encourage people to subscribe, cellular telephone carriers would often subsidize the price of a cellular telephone assuming they would make up the cost of the phone over the subscription period. Again, this assumes a certain credit worthiness on the part of the subscriber, coupled with an ability for the cellular telephone carrier, or service provider, to enforce the terms of the agreement. For example, when the subscriber did not pay the subscription fee or monthly bill, the carrier could simply not allow the cellular telephone access to the network. Most cellular telephones, particularly those that are subsidized, have little or no value when they cannot be used to make telephone calls.

The model of subsidized equipment in return for subscription fees over a period of time is attractive for other types of equipment, for example computer systems, especially in underdeveloped areas of the world. However, unlike cellular telephones, the difficulty associated with subsidized offering of computers is the inherent value of the system, as well as the significant functionality of a computer available to a user when the computer is disconnected from any network or other service provider-controlled access point.

### SUMMARY

A system for delivering subsidized computer equipment uses provider-side resources for activating computers and for providing consumable licenses or provisioning packets for use by the computer in a pay-per-use or a subscription fashion. Pay-per-use, pay-as-you go, subscription, and similar schemes, may generally be referred to as metered operation. Provisioning packets, pay-per-use minutes, pay-as-you-go value accumulation, and subscription period authorizations may generally be referred to as a license. While the computer in total may be licensed for metered operation, individual components, including hardware, software or both, may also be licensed for metered operation. Various offers may be made to underwrite all or a portion of a computer. Since different entities may subsidize or sponsor the offers, an identifier including a particular hardware identifier for that computer and an underwriter/ provider identifier for a particular offer may be used to identify the individually underwritten component or service.

By using an identifier that includes both a specific computer ID and the offer ID, licensing may be both granular and provider specific. The license may not be used on another computer nor can the license be used on the designated computer for provisioning a different asset. Because each offer is accounted for separately at the host side, underwriter/providers have the capability to identify and track payment by offer, by computer. The provider-side resource, such as a server, may be coupled to any of a number of current or future payment processing systems to complete financial transactions. For example, links may be established to credit card, debit card, scratch card prepay, or banks, among others, to complete payment transactions. Incentive plans, such as providing a license in exchange for watching a prescribed number of advertisements may also be used.

### BRIEF DESCRIPTION OF THE DRAWINGS

FIG. 1 is a block diagram of a network interconnecting a plurality of computing resources;

FIG. 2 is a block diagram of a system in accordance with an embodiment of the current disclosure; and

FIG. 3 is a block diagram of a system supporting metered operation of a computer.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term s expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the various embodiments.

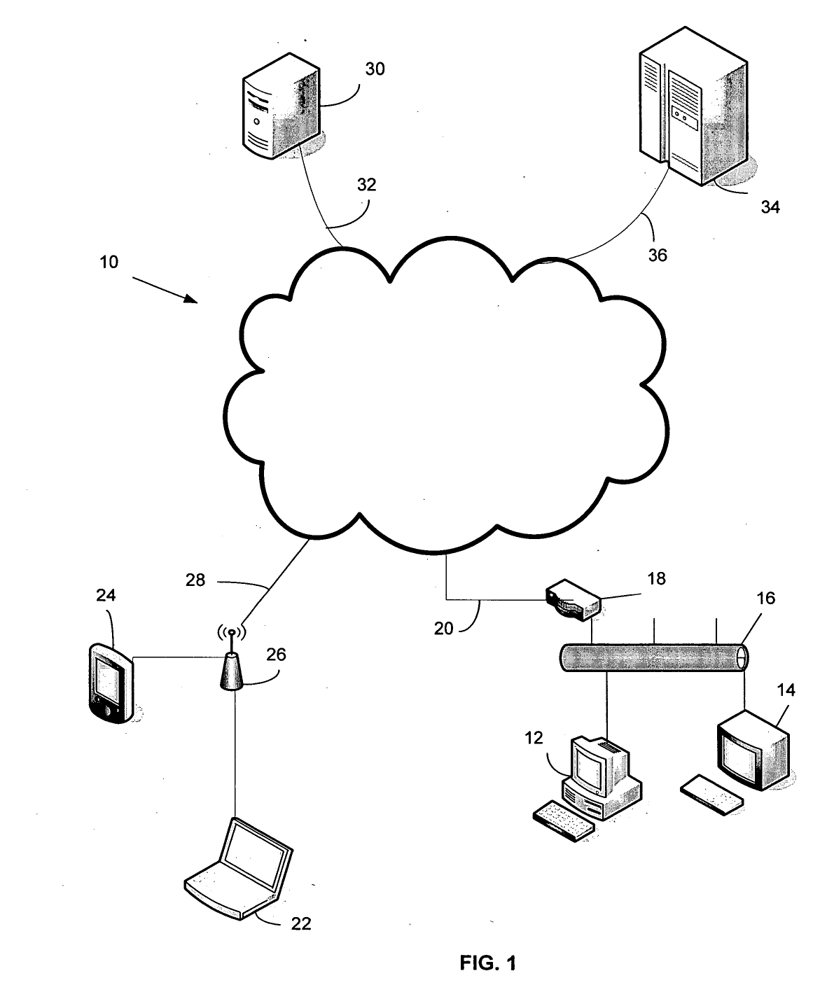

FIG. 1 illustrates a network 10 that may be used to implement a metered use licensing system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet connection 16, a router 18, and a landline 20. On the other hand, the network 10 may be wirelessly connected to a laptop computer 22 and a personal digital assistant 24 via a wireless communication station 26 and a wireless link 28. Similarly, a server 30 may be connected to the network 10 using a communication link 32 and a mainframe 34 may be connected to the network 10 using another communication link 36.

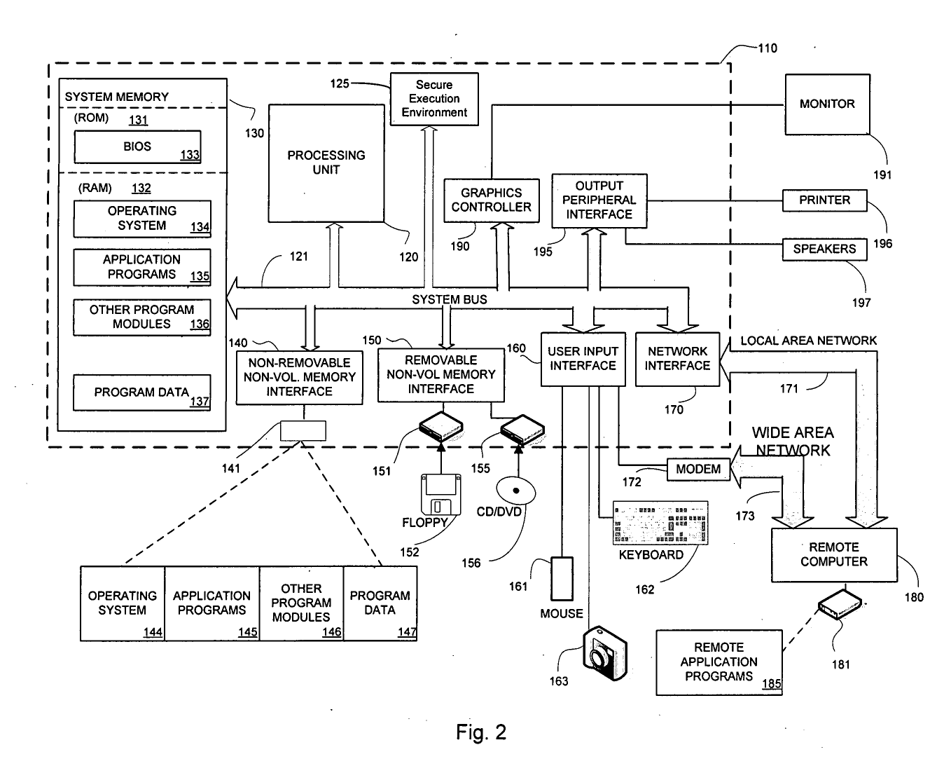

FIG. 2 illustrates a computing device in the form of a computer 110 that may be connected to the network 10 and used to implement one or more components of the dynamic software provisioning system. Components of the computer 110 may include, but are not limited to,.a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

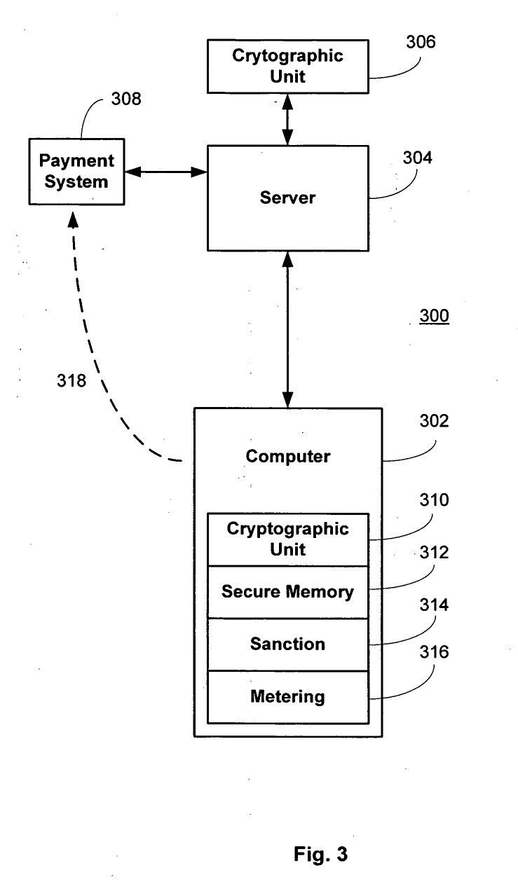

The processing unit 120 may also include a secure execution environment 125. The secure execution environment 125 may be used to host a variety of security functions from cryptographic processing to metering and balance management. The roles of the secure execution environment 125 are discussed more below with regard to FIG. 3.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory, such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Another input device may be a camera for sending images over the Internet, known as a web cam 163. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

FIG. 3 is a block diagram of a system supporting metered operation of a computer. The system 300 includes a computer 302 and a server 304. A cryptographic unit 306 may be part of the server 304 or a separate device. A payment system 308, coupled to the server 304, may be used in conjunction with provisioning metered functionality for the computer 302.

The computer 302 may have additional capability, often included with the secure execution environment 125, for administration and execution of the metered operation of the computer 110. A cryptographic unit 310 may be used for standard encryption and digital signature processing. A secure memory 312 may store data in a tamper-resistant manner. A sanction function 314 and metering function 316 may be used to enforce terms of a usage agreement and will be discussed more below. The cryptographic unit 310 and sanction and metering functions 314 316 may be implemented in hardware or software, depending on the needs of the particular operating environment and associated risk factors.

In operation, a user may receive a computer or similar electronic device for use in a metered fashion. A service provider, or other underwriter, may provide the computer at a reduced price, or even free, in exchange for a commitment from the user for payments covering the use of the computer 302. Metered use may be governed via a subscription, for example, for unlimited monthly use or may be on a pay-per-use basis where actual computer time is purchased and consumed. Metering may also be used for not only the computer as a whole, but for individual elements both hardware and software. The term offer is used to describe any element or combination subject to licensed use, including the whole computer 302. Computer asset also refers to the whole computer or portions thereof, either hardware, software or combinations.

In addition, services may be purchased and provided in a similar manner, for example, Internet access, may also be covered by a subscription or other metered basis (e.g. per minute.).

The user may initially register the computer 302 with the server 304. The registration request may include a hardware identifier, an underwriter provider identifier, and an initialization key. The server 304 may confirm the validity of the identifiers and initialization key and return a certificate to the computer 302 for use in processing licenses. Once the computer 302 has received and verified at least one certificate corresponding to an offer, the user may request a license to enable use of the computer or the metered element. Communication between the server 304 and the computer 302 may be via a network, such as network 10 of FIG. 1, but may also include removable media or even manually entered data.

The server 304 may receive the request for the license and verify the identifier. The identifier may include both the hardware ID of the computer and the underwriter ID, the combination of identifiers uniquely identifying a particular offer, be it the whole computer or individual elements. As mentioned above, individual underwriters may participate in offers covering different aspects of the computer 302 or its operation.

A user may provide finds via path 318 to the payment system 308 in a customary manner. As discussed above, the payment system 308 may be one or more known transaction systems, such as credit, debit, or prepaid. In processing the request for a license, the server 304 may verify availability of funds at the payment system 308 and either transfer the funds or reserve funds for transfer after the successful completion of the license transaction. The accumulation of funds at either the payment system 308 or the server 304 may vary based on the scheme used, that is, in a credit system, value may be accumulated at the server 304 and an offsetting payment made at the end of the period. Conversely, when using a prepaid system funds may be transferred at the beginning of the period. In either case, according to one embodiment, value may be transferred only after confirmation of delivery of the. license to the computer 302. In another embodiment, value may be transferred immediately after generation and sending of a license.

The server 304 may then generate a license (also referred to as a provisioning packet) for consumption by the computer 302. The license may be signed and may also include the unique combination of hardware ID and underwriter ID. The signature may be executed by the cryptographic unit 306. The cryptographic unit 306 may be incorporated in the server 304 or may be separate. For example, the cryptographic unit 306 may be part of a service similar to those found at a certificate authority. The license may also include a sequence number to prevent replay on the designated computer 302.

The combination of hardware identifier and underwriter identifier allow multiple offers to be maintained on one computer 302. The combination both prevents use of the license on other computers as well as maintains an auditable financial trail for the individual offer providers.

The license may then be received at the computer 302, and verified by the cryptographic unit 310. Verification may include confirming the digital signature of the license, confirming the identifier, or confirming validity of the sequence number. When the license verification is successful, the computer 302 or other licensed offer may be utilized in a normal fashion. Optionally, a confirmation may be sent to the server 304. The license may convey metering use in appropriate units, e.g. minutes, and may be securely stored as a balance value in the secure memory 312. While in use, metering may take place and a value associated with the license may be consumed according to a particular payment schedule. In one embodiment, a pay-as-you-go example, the license conveys the designated number of minutes of usage and the metering determines the number of minutes the computer is in use. The payment schedule may be in minutes and the metering in minutes is used for consuming the value of the license. In another exemplary embodiment, a subscription, the license may convey unlimited use for 30 days. The payment schedule in this case may be a 30-day period and the metering becomes essentially checking for an end date. In yet another example, the use of a printer, the payment schedule is in sheets printed and the metering corresponds to the number of printing operations. Another embodiment may cover Internet access at different rates according to the time of day. In this case, even though metering is in minutes the payment schedule may vary based on the time of day so that off-peak Internet use may consume value at a different rate from a peak period, for example, one half minute per minute of metered time.

When the value conveyed by the license has been consumed or reaches some other designated threshold, the computer 302, or specific offer associated with the computer 302, may be limited in operation, except to allow requesting and receiving a new license. The limitation may range from a warning, to a reduction in performance, to a system reset, to a complete shut down of the system, depending on the license terms and attempts to use the computer 302 or other offer after the threshold has been reached.

Further, the computer 302 is likely to be the target for hacking and other attacks to attempt to enable use outside the metered scheme. Therefore, a policy may be in place that specifies monitoring and measurement of the system to determine whether the computer 302 is under attack or has been compromised. When it is determined that the policy has been violated, including an inability to monitor and/or measure, the operation of the computer or the asset may similarly be limited as above.

The concepts and techniques discussed above allow the model of subsidized purchase based on future use to be extended from current network-based models such as cellular telephones to computers and similar electronic devices even when network connectivity is sporadic or unavailable. The use of dual identifiers for the hardware and for offers representing either the whole computer or elements of the computer provides for granular licensing of capability while maintaining financial accountability for the offer provider. The ability of the computer 302 to self-meter and self-impose sanctions provides the underwriter with recourse against fraudulent use of the provided computer, computer component, or other combination even when disconnected from a network.

One of ordinary skill in the art will appreciate that various modifications and changes can be made to the above embodiments, including but not limited to the use of different combinations of hardware or software for activity monitoring and sanctioning. Accordingly, the specification and drawings are to be regarded in an illustrative rather than restrictive sense, and all such modifications are intended to be included within the scope of the present patent.

We claim:

1. A method of licensing use of a computer asset comprising:
receiving at a server a request for a license, the license for metered utilization of the computer asset, the request including an identifier that uniquely identifies a computer comprising the computer asset;
generating the license for the metered utilization of the computer asset, the license incorporating the identifier;
receiving the license at the computer;
verifying the license;
utilizing the computer asset after the verifying the license is successful;
metering the utilization of the computer asset;
consuming a value associated with the license at a rate corresponding to a payment schedule and the metering; and
limiting utilization of the computer asset when the value associated with the license reaches a threshold.

2. The method of claim 1, further comprising:
setting a policy corresponding to operation of the computer asset; and
limiting operation of the computer asset when violation of the policy is determined.

3. The method of claim 1, further comprising signaling the server when the verifying the license is successful.

4. The method of claim 1, further comprising accumulating a charge associated with the license against a payment account.

5. The method of claim 4, wherein the accumulating a charge associated with the license comprises accumulating a charge associated with the license after signaling the server when the verifying the license is successful.

6. The method of claim 1, wherein the identifier comprises a hardware identifier and a service provider identifier.

7. The method of claim 1, wherein generating the license comprises digitally signing the license.

8. The method of claim 1, wherein the verifying the license comprises verifying the license using a cryptographic capability at a secure execution environment of the computer.

9. A system for licensing metered-use of an asset associated with a computer comprising:
a server for processing a request for a license associated with metered use of the asset; and
the computer having an identifier unique within a sphere of operation, the computer coupled to the server and operable to request and receive the license, the computer further operable to cryptographically verify the license and meter use of the asset in accordance with a term of the license.

10. The system of claim 9, further comprising a cryptographic unit coupled to the server, the cryptographic unit for authenticating the request from the computer for the license, the request including the identifier.

11. The system of claim 9, further comprising a cryptographic unit coupled to the server, for generating a key pair and a certificate including the identifier responsive to a registration request from the computer wherein the registration request includes the identifier.

12. The system of claim 9, further comprising a payment system for processing payments corresponding to processing the request for the license associated with metered use of the asset.

13. The system of claim 12, wherein the payment system is one of a credit system, a debit system, a prepaid system, and a postpaid system.

14. The system of claim 9, wherein the computer comprises a metering circuit for metering the use of the asset in accordance with the term of the license.

15. The system of claim 14, wherein the metering circuit of the computer comprises a capability for limiting use of the asset when the term of the license is reached.

16. The system of claim 9, wherein the computer comprises a cryptographic circuit for cryptographically signing the request and cryptographically verifying the license.

17. The system of claim 9, wherein the computer comprises a secure memory for storing the identifier, the identifier comprising a hardware identifier and a third party identifier.

18. The system of claim 9, wherein the computer comprises a sanction function determining operation in compliance with an operation policy and for limiting a function of the computer when operation of the computer is out of compliance with the operation policy.

19. A computer for use in a metered business model comprising:
a processor;
a secure memory coupled to the processor for storing an identifier, the identifier comprising a hardware identifier associated with the computer and a provider identifier;
a cryptographic unit coupled to the processor; and
an input/output circuit for conveying a registration request to a service provider, the request including the identifier, the input/output circuit further for receiving a registration response, wherein the processor activates the cryptographic unit to confirm a digital signature of the registration response and the processor is operable to store a portion of the registration response in the secure memory.

20. The computer of claim 19, further comprising a secure execution environment wherein the input/output circuit is operable to receive a provisioning packet comprising the identifier and a license to use at least one asset of the computer, wherein the cryptographic unit is operable to verify the provisioning packet using the stored portion of the registration response and the secure execution environment meters the use of the at least one asset in accordance with the license.
